(19) United States
(12) Patent Application Publication
(10) Pub. No.: US 2024/0373310 A1
(43) Pub. Date: Nov. 7, 2024

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US); Mitsutaka HATA, Yokohama-shi (JP)

(73) Assignee: KYOCERA Corporation, Kyoto (JP)

(21) Appl. No.: 18/771,638

(22) Filed: Jul. 12, 2024

Related U.S. Application Data
(63) Continuation of application No. PCT/JP2023/000001, filed on Jan. 4, 2023.
(60) Provisional application No. 63/299,604, filed on Jan. 14, 2022.

(51) Int. Cl. H04W 36/08; H04W 36/00; H04W 74/0833; H04W 76/10

(52) U.S. Cl. CPC H04W 36/08; H04W 36/0044; H04W 74/0833; H04W 76/10

(57) ABSTRACT

In an aspect, a communication control method is used in a mobile communication system in which communication is performed between a remote user equipment and a base station via a first relay user equipment. The communication control method includes a step of transmitting, by the first relay user equipment, first slice support information to the remote user equipment, the first slice support information including network slices capable of being supported by the first relay user equipment. The communication control method also includes a step of performing, by the remote user equipment, reselection processing of reselecting a relay user equipment supporting a desired network slice that the remote user equipment desires to use, based on the first slice support information.

### RELATED APPLICATIONS

The present application is a continuation based on PCT Application No. PCT/JP2023/000001, filed on Jan. 4, 2023, which claims the benefit of U.S. Provisional Patent Application No. 63/299,604 filed on Jan. 14, 2022. The content of which is incorporated by reference herein in their entirety.

### TECHNICAL FIELD

The present disclosure relates to a communication control method used in a mobile communication system.

### BACKGROUND

For a mobile communication system based on the 3rd Generation Partnership Project (3GPP) standard, a technology of sidelink relay using a user equipment as a relay node has been under study (e.g., see “3GPP TS 38.300 V16.8.0 (2021-12)”). The sidelink relay is a technology in which a relay node referred to as a relay user equipment (Relay UE) mediates communication between a base station and a remote user equipment (Remote UE) and relays the communication.

### SUMMARY

In a first aspect, a communication control method is used in a mobile communication system in which communication is performed between a remote user equipment and a base station via a first relay user equipment. The communication control method includes transmitting, by the first relay user equipment, first slice support information to the remote user equipment, the first slice support information including a network slice that the first relay user equipment is configured to support. The communication control method also includes performing, by the remote user equipment, reselection processing of reselecting a relay user equipment supporting an intended network slice that the remote user equipment intends to use, based on the first slice support information.

In a second aspect, a communication control method is used in a mobile communication system in which communication is performed between a remote user equipment and a base station via a relay user equipment. The communication control method includes transmitting, by the base station, mapping information indicating mapping between a network slice and a resource pool to the relay user equipment The communication control method includes transmitting, by the relay user equipment, the mapping information to the remote user equipment. Further, the communication control method includes performing, by the remote user equipment and the relay user equipment, the communication with each other using the resource pool, based on the mapping information.

In a third aspect, a communication control method is used in a mobile communication system in which communication is performed between a remote user equipment and a base station via a first relay user equipment. The communication control method includes transmitting, by the remote user equipment to the first relay user equipment, a connection request message to establish a connection to the first relay user equipment. The communication control method includes transmitting, by the remote user equipment to the first relay user equipment, a predetermined message to cause the first relay user equipment to establish a connection to the base station. Further, the communication control method includes performing, by the first relay user equipment, a random access procedure with the base station by using an RACH resource associated with an identifier of a network slice included in either the connection request message or the predetermined message.

### BRIEF DESCRIPTION OF THE DRAWINGS

FIG. 1 is a diagram illustrating a configuration example of a mobile communication system 1 according to a first embodiment.

FIG. 2 is a diagram illustrating a configuration example of a UE according to the first embodiment.

FIG. 3 is a diagram illustrating a configuration example of a gNB according to the first embodiment.

FIG. 4 is a diagram illustrating a configuration example of a protocol stack of a user plane according to the first embodiment.

FIG. 5 is a diagram illustrating a configuration example of a protocol stack of a control plane according to the first embodiment.

FIG. 6 is a diagram illustrating an assumed scenario according to the first embodiment.

FIG. 7 is a diagram illustrating a configuration example of a protocol stack of a user plane in the assumed scenario according to the first embodiment.

FIG. 8 is a diagram illustrating a configuration example of a protocol stack of a control plane in the assumed scenario according to the first embodiment.

FIG. 9 is a diagram illustrating an operation example according to the first embodiment.

FIG. 10 is a diagram illustrating an operation example according to a variation of the first embodiment.

FIG. 11 is a diagram illustrating an example of resource pool allocation according to a second embodiment.

FIG. 12 is a diagram illustrating an operation example according to the second embodiment.

FIG. 13 is a diagram illustrating an operation example according to a third embodiment.

FIG. 14 is a diagram illustrating an operation example according to a variation of the third embodiment.

### DESCRIPTION OF EMBODIMENTS

A mobile communication system according to an embodiment is described with reference to the drawings. In the description of the drawings, the same or similar parts are denoted by the same or similar reference signs.

### Configuration Example of Mobile Communication System

In an embodiment, a configuration example of a mobile communication system is described. In the embodiment, a mobile communication system 1 is a 3GPP 5G system. Specifically, a radio access scheme in the mobile communication system 1 is New Radio (NR) being a radio access scheme of the 5G. Note that Long Term Evolution (LTE) may be at least partially applied to the mobile communication system 1. Future mobile communication systems such as the 6G may be applied to the mobile communication system 1.

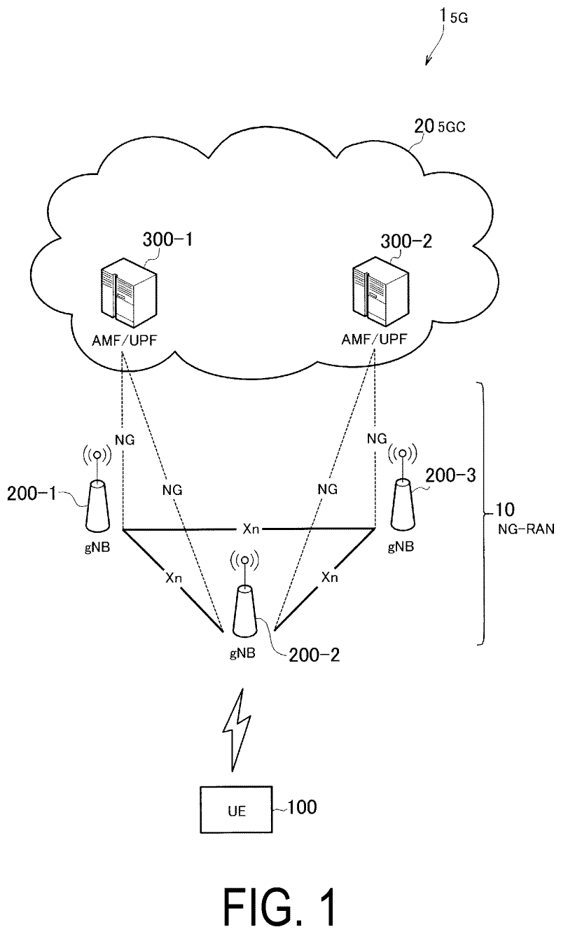

FIG. 1 is a diagram illustrating a configuration example of the mobile communication system 1 according to an embodiment.

As illustrated in FIG. 1, the mobile communication system 1 includes a User Equipment (UE) 100, a 5G radio access network (Next Generation Radio Access Network (NG-RAN)) 10, and a 5G Core Network (5GC) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency. Note that, hereinafter, the “cell” and the base station may be used without distinction.

Note that the gNB 200 can be connected to an Evolved Packet Core (EPC) corresponding to a core network of LTE. An LTE base station can also be connected to the 5GC 20. The LTE base station and the gNB 200 can be connected to each other via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between the base station and the core network.

### Configuration of User Equipment

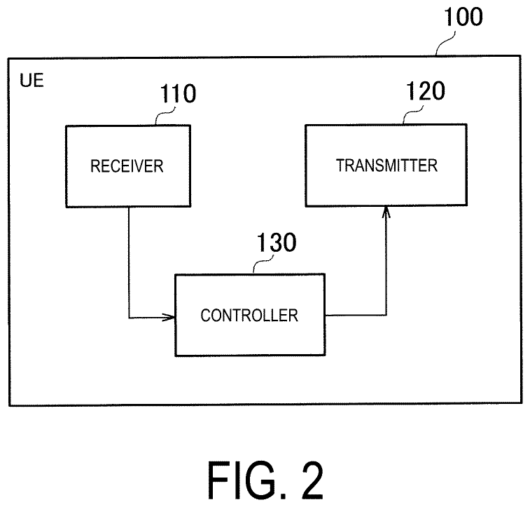

In the embodiment, a configuration example of the UE 100 that is a user equipment is described. FIG. 2 is a diagram illustrating the configuration example of the UE 100.

As illustrated in FIG. 2, the UE 100 includes a receiver 110, a transmitter 120, and a controller 130.

The receiver 110 performs various types of reception under control of the controller 130. The receiver 110 includes an antenna and converts (down-converts) a radio signal received by the antenna into a baseband signal (reception signal) which is then output to the controller 130.

The transmitter 120 performs various types of transmission under control of the controller 130. The transmitter 120 includes an antenna and converts (up-converts) the baseband signal (transmission signal) output by the controller 130 into a radio signal which is then transmitted from the antenna.

The controller 130 performs various types of control in the UE 100. The controller 130 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. Note that the controller 130 may perform respective processing operations and/or respective operations in the UE 100 in each embodiment described below.

### Configuration Example of Base Station

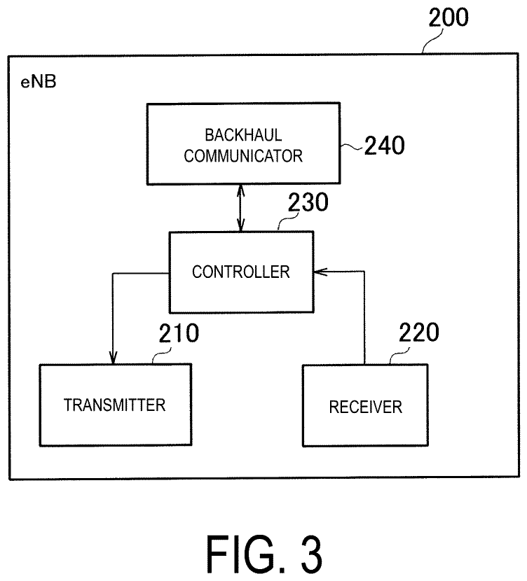

In the embodiment, a configuration example of the gNB 200 that is a base station is described. FIG. 3 is a diagram illustrating a configuration example of the gNB 200.

As illustrated in FIG. 3, the gNB 200 includes a transmitter 210, a receiver 220, a controller 230, and a backhaul communicator 240.

The transmitter 210 performs various types of transmission under control of the controller 230. The transmitter 210 includes an antenna and converts (up-converts) a baseband signal (transmission signal) output by the controller 230 into a radio signal which is then transmitted from the antenna.

The receiver 220 performs various types of reception under control of the controller 230. The receiver 220 includes an antenna and converts (down-converts) a radio signal received by the antenna into a baseband signal (reception signal) which is then output to the controller 230.

The controller 230 performs various types of controls for the gNB 200. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. Note that, the controller 230 may perform respective processing operations and/or respective operations in the gNB 200 in each embodiment described below.

The backhaul communicator 240 is connected to a neighboring base station via the Xn interface. The backhaul communicator 240 is connected to the AMF and UPF 300 via the NG interface. Note that the gNB 200 may include a Central Unit (CU) and a Distributed Unit (DU) (i.e., functions are divided), and both units may be connected via an F1 interface.

### Configuration Example of Protocol Stack

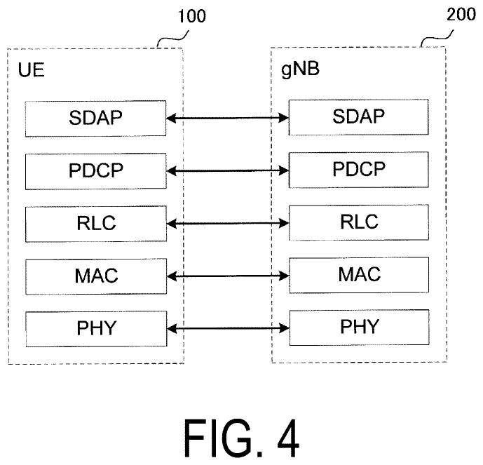

FIG. 4 is a diagram illustrating a configuration example of a protocol stack of a radio interface of a user plane handling data.

As illustrated in FIG. 4, a radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer. Note that, in the following, a layer and an entity may be used without distinction.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression and decompression, and encryption and decryption.

The SDAP layer performs mapping between an IP flow as the unit of Quality of Service (QoS) control performed by a core network and a radio bearer as the unit of QoS control performed by an AS (access stratum). Note that, when the RAN is connected to the EPC, the SDAP need not be provided.

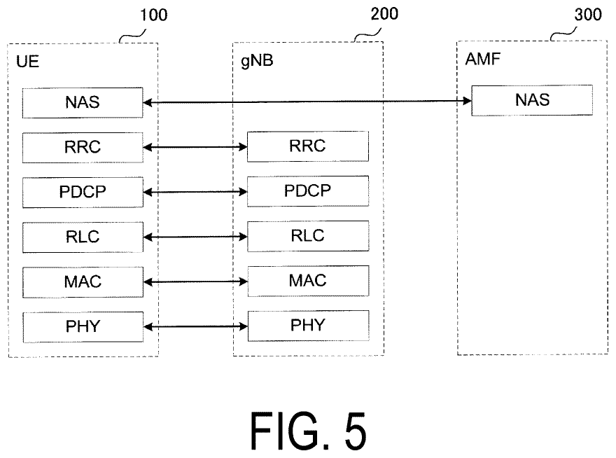

FIG. 5 is a diagram illustrating a configuration of a protocol stack of a radio interface of a control plane handling signaling (a control signal).

As illustrated in FIG. 5, the protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 exists, the UE 100 is in an RRC connected state. When no connection (RRC connection) between the RRC of the UE 100 and the RRC of the gNB 200 exists, the UE 100 is in an RRC idle state. When the RRC connection is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of the AMF 300.

Note that the UE 100 includes an application layer other than the protocol of the radio interface.

### First Embodiment

A first embodiment is described.

### Assumed Scenario

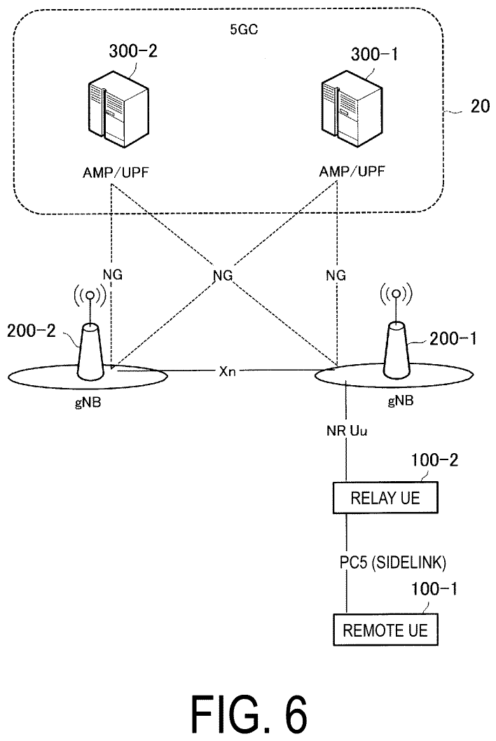

According to the first embodiment, an assumed scenario for the mobile communication system 1 is described. FIG. 6 is a diagram illustrating the assumed scenario.

As illustrated in FIG. 6, a scenario is assumed that uses sidelink relay in which a relay UE 100-2 mediates a communication between the gNB 200-1 and a remote UE 100-1 and relays the communication. In other words, in the scenario, the gNB 200-1 and the remote UE 100-1 communicate via the relay UE 100-2.

The remote UE 100-1 performs wireless communication (sidelink communication) with the relay UE 100-2 on a PC5 interface (sidelink) used as an inter-UE interface. The relay UE 100-2 performs wireless communication (Uu communication) with the gNB 200-1 on an NR Uu interface. As a result, the remote UE 100-1 indirectly communicates with the gNB 200-1 via the relay UE 100-2. The Uu communication includes uplink communication and downlink communication.

### Configuration Example of Protocol Stack in Assumed Scenario

A configuration example of a protocol stack in the assumed scenario is described.

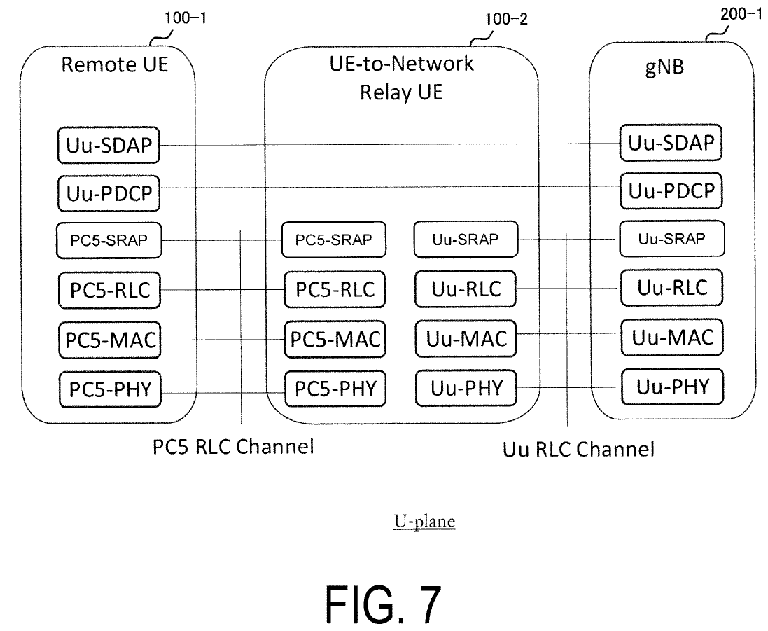

FIG. 7 is a diagram illustrating an example of a protocol stack of a user plane in the assumed scenario. FIG. 7 is also an example of a protocol stack of a user plane in relay via the relay UE 100-2 (i.e., U2N (UE to Network) relay).

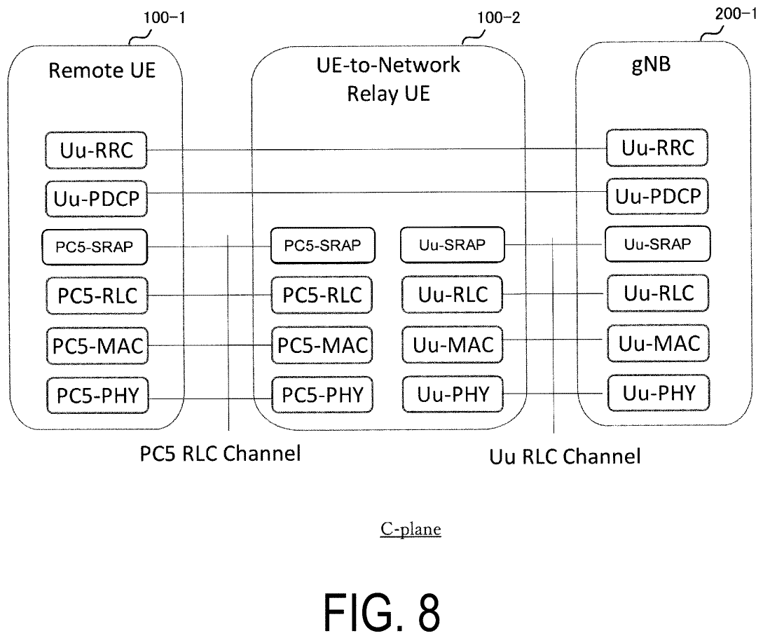

FIG. 8 is a diagram illustrating an example of a protocol stack of a control plane in the assumed scenario. FIG. 8 is also an example of a protocol stack of a control plane in the U2N relay.

As illustrated in FIG. 7, the gNB 200-1 includes a Uu-SRAP (sidelink relay adaptation protocol) layer, a Uu-RLC layer, a Uu-MAC layer, and a Uu-PHY layer which are used for communication on the NR Uu interface (Uu communication).

The relay UE 100-2 includes a Uu-SRAP layer, a Uu-RLC layer, a Uu-MAC layer, and a Uu-PHY layer which are used for communication on the NR Uu interface (Uu communication). The relay UE 100-2 includes a PC5-SRAP layer, a PC5-RLC layer, a PC5-MAC layer (PC5), and a PC5-PHY layer which are used for communication on the PC5 interface (PC5 communication).

The remote UE 100-1 includes a Uu-SDAP layer and a Uu-PDCP layer which are used for communication on a Uu interface (Uu). The remote UE 100-1 includes a PC5-SRAP layer, a PC5-RLC layer, a PC5-MAC layer (PC5), and a PC5-PHY layer which are used for communication on the PC5 interface (PC5 communication).

As illustrated in FIG. 8, in the control plane, a Uu-RRC layer is disposed instead of the Uu-SDAP layer of the user plane.

As illustrated in FIGS. 7 and 8, the SRAP layers are disposed on the Uu interface and the PC5 interface. Each SRAP layer is an example of a so-called adaptation layer. The SRAP layer is present only in a layer 2 relay and does not exist in a layer 3 relay. The SRAP layer is present in all of the remote UE 100-1, the relay UE 100-2, and the gNB 200-1. Further, the SRAP layer includes two layers of PC5-SRAP and Uu-SRAP. The PC5-SRAP and the Uu-SRAP each have a bearer mapping function. For example, the bearer mapping function is as follows. In other words, the remote UE 100-1 and the Uu-SRAP of gNB 200-1 perform mapping between the bearer (Uu-PDCP) and the PC5 RLC channel (PC5-RLC). The PC5-SRAP and the Uu-SRAP of the relay UE 100-2 perform mapping between the PC5 RLC channel (PC5-RLC) and the Uu RLC channel (Uu-RLC). Further, the Uu-SRAP has an identification function of the remote UE 100-1.

Note that, although not illustrated in FIGS. 7 and 8, each of the remote UE 100-1 and the relay UE 100-2 may include an RRC layer for PC5. Such an RRC layer is referred to as a “PC5-RRC layer”. The PC5-RRC connection and the PC5 unicast link between the remote 100-1 and the UE 100-2 are in a one-to-one correspondence, and the PC5-RRC connection is established after the PC5 unicast link is established.

Although not illustrated in FIGS. 7 and 8, each of the remote UE 100-1 and the relay UE 100-2 may include a PC5-S(signaling) protocol layer. The PC5-S protocol layer is an upper layer of the PDCP layer. Like the PC5-RRC layer, the PC5-S protocol layer is also a layer for transmission of control information.

### Communication Control Method in First Embodiment

In the first embodiment, a communication control method is described. In the first embodiment, relay reselection in consideration of network slicing in the assumed scenario is described. Such relay reselection is referred to as “slice-specific relay reselection”.

In describing the slice-specific relay reselection, an overview of network slicing is first described. Next, the slice-specific cell reselection is described. Then, the relay reselection is described. After that, slice-specific relay reselection according to the first embodiment is described.

### Network Slicing

Network slicing is a technique for creating a plurality of virtual networks by virtually dividing a physical network (e.g., a network including the NG-RAN 10 and the 5GC 20) constructed by a business operator. Each of the virtual networks is referred to as a network slice. Hereinafter, the network slice may be simply referred to as the “slice”.

Each slice is assigned with a slice identifier for identifying the slice. Examples of the slice identifier include Single Network Slice Selection Assistance Information (S-NSSAI). The S-NSSAI includes an 8-bit slice/service type (SST). The S-NSSAI may further include a 24-bit slice differentiator (SD). The SST is information indicating a service type with which the slice is associated. The SD is information for differentiating a plurality of slices associated with the same service type. Information including a plurality of S-NSSAIs is referred to as Network Slice Selection Assistance Information (NSSAI).

One or more slices may be grouped to form a slice group. A slice group is a group including one or more slices, and is assigned with a slice group identifier. The slice group may be configured to include a core network (e.g., AMF 300) or may be configured to include a radio access network (e.g., gNB 200-1). A notification indicating the configured slice group may be transmitted to the UE 100.

Hereinafter, the term “slice” or “slicing” may refer to an S-NSSAI that is an identifier of a single slice or an NSSAI that is a collection of S-NSSAIs. The term “slice” or “slicing” may refer to a slice group that is a group of one or more S-NSSAIs or NSSAIs.

The UE 100 determines a desired slice that the UE 100 wants to use. Such a desired slice may be referred to as an “intended slice”.

In the 3GPP, RAN slicing is discussed in consideration of network slicing at the RAN level. For example, the RAN slicing is expected to enable radio resource allocation supporting slices, Quality of Service (QoS) supporting slices, or the like, to be implemented.

### Slice-Specific Cell Reselection

Slice-specific cell reselection is described.

In the 3GPP, introduction of the slice-specific cell reselection in the RAN slicing is discussed. The slice-specific cell reselection is processing performed in order for the UE 100 in the RRC idle state or the RRC inactive state to change from a current serving cell (e.g., cell #1) to a neighboring cell (e.g., cell #2) when moving.

The slice-specific cell reselection is performed using slice frequency information received from the network or held. The slice frequency information includes, for example, for each slice (or slice group), a frequency (one or more frequencies) supporting the slice and a frequency priority assigned to each frequency.

In the slice-specific cell reselection, the following processing is performed.

First, a NAS of the UE 100 notifies the AS of slice information including the slice identifiers of the desired slices of the UE 100 and slice priorities of the respective desired slices. The “desired slice” refers to the intended slice as described above and includes a slice that is likely to be used, a candidate slice, a preferred slice, a slice with which to communicate, a requested slice, an allowed slice, or an intended slice.

Second, the AS of the UE 100 rearranges the slices (or slice identifiers) notified from the NAS in descending order of slice priority.

Third, the AS of the UE 100 selects one slice in descending order of slice priority, and for the selected slice, assigns a frequency priority to each of the frequencies associated with the selected slices. The AS of the UE 100 assigns the frequency priority, based on the slice frequency information.

Fourth, the AS of the UE 100 selects one frequency in descending order of frequency priority for the selected slice, and performs measurement processing on the selected frequency.

Fifth, the AS of the UE 100 specifies the highest ranked cell, based on the results of the measurement processing and judges whether the cell can provide the selected slice. The judgment is made based on cell information received (or held) in advance. The cell information may include information indicating a correspondence between a cell (e.g., a serving cell and each neighboring cell) and a slice that is not provided or provided by the cell.

Sixth, when the AS of the UE 100 judges that the highest ranked cell provides the selected slice, the AS of the UE 100 reselects the highest ranked cell and camps on that cell. On the other hand, when the AS of the UE 100 judges that the highest ranked cell cannot provide the selected slice, the AS of the UE 100 selects a frequency having the next highest priority, performs the measurement processing on the frequency, and repeats the above-described processing. When no frequency to be subjected to the measurement processing exists for the selected slice, the AS of the UE 100 selects a selected slice having the next highest slice priority and repeats the above-described processing for the selected slice.

This allows, for example, the UE 100 to preferentially reselect the cell supporting the desired slice desired by the UE 100 and appropriately communicate with the cell.

### Relay Reselection

The relay reselection is described.

The 3GPP discusses introduction of the relay reselection in a sidelink relay. The relay reselection is performed, for example, in order the UE 100 in the RRC idle state or the RRC inactive state to migrate from the current relay UE (e.g., relay UE #1) to another relay UE (e.g., relay UE #2) when moving.

The remote UE 100-1 may perform the relay reselection when a frequency used for sidelink communication is outside a coverage range. The remote UE 100-1 may also perform the relay reselection when an RSRP measurement of the cell on which the remote UE 100-1 camps is lower than a predetermined value. The remote UE 100-1 selects a relay UE of which a Sidelink Discovery Reference Signal Received Power (SD-RSRP) exceeds a minimum received RSRP level (minimum received quality level) as a candidate relay UE. The remote UE 100-1 may select the candidate relay UE having the highest-quality radio link (i.e., PC5 unicast link) among all the candidate relay UEs meeting a predetermined criterion as the relay UE for reselection. Then, the remote UE 100-1 reselects and camps on the relay UE.

Note that the same and/or similar processing may be performed for the relay selection.

### Slice-Specific Relay Reselection According to First Embodiment

The above-described relay reselection is not considered for slices. Thus, for example, UE 100 may not always reselect the relay UE 100-2 supporting the desired slice (intended slice) through the relay reselection. Therefore, appropriate communication may not be performed in the assumed scenario.

Although the above-described slice-specific cell reselection is considered for cells, an appropriate operation may not be necessarily performed in the assumed scenario of sidelink relay.

Therefore, in the first embodiment, the relay reselection in consideration of a slice (that is, slice-specific relay reselection) in the assumed scenario is described.

To be specific, first, a first relay user equipment (e.g., relay UE 100-2) transmits first slice support information to a remote user equipment (e.g., remote UE 100-1), the first slice support information including network slices capable of being supported by the first relay user equipment. Second, the remote user equipment performs reselection processing of reselecting a relay user equipment supporting a desired network slice (e.g., desired slice (intended slice)) that the remote user equipment desires to use, based on the first slice support information.

This allows the remote UE 100-1 to reselect the relay UE 100-2 supporting the desired slice to appropriately perform communication via sidelink relay.

### Operation Example According to First Embodiment

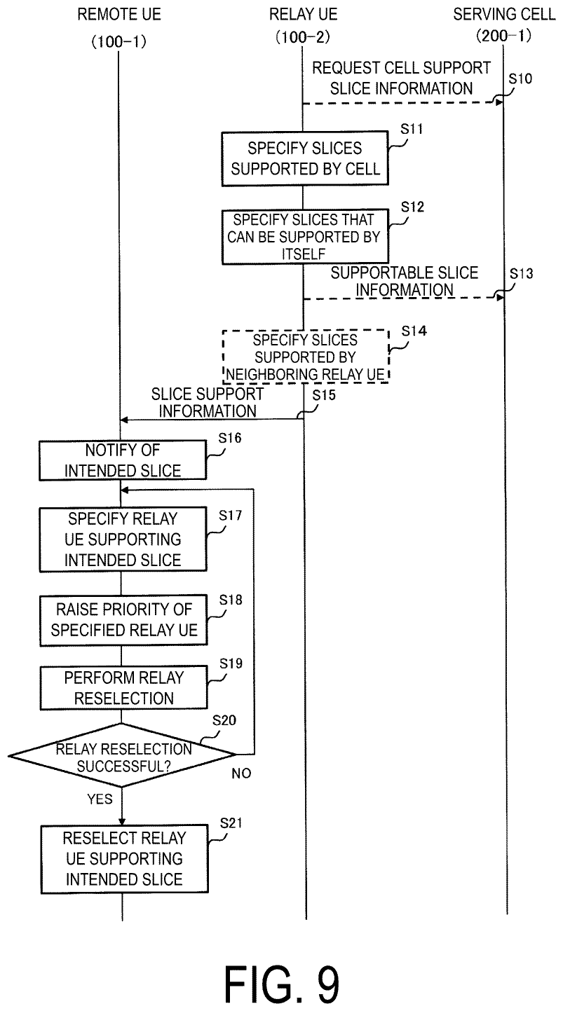

FIG. 9 is a diagram illustrating an operation example according to the first embodiment. FIG. 9 illustrates a procedure for the slice-specific relay reselection.

Note that the remote UE 100-1, during the operation illustrated in FIG. 9, is in the RRC idle state or the RRC inactive state. A PC5 connection may be disconnected or established between the remote UE 100-1 and the relay UE 100-2. The relay UE 100-2 during the operation illustrated in FIG. 9, may be in the RRC connected state, the RRC idle state, or the RRC inactive state.

As illustrated in FIG. 9, in step S10, the relay UE 100-2 may request the serving cell of the gNB 200-1 to provide information indicating slices supported by the serving cell (hereinafter, may be referred to as “cell supported slice information”). Step S10 may be a step in which a predetermined layer of the relay UE 100-2 transmits a message of the predetermined layer including the request to a predetermined layer of the gNB 200-1. The predetermined layer may be any one of the Uu-PHY layer, the Uu-MAC layer, the Uu-RLC layer, or the Uu-SRAP layer in the Uu link.

In step S11, the relay UE 100-2 specifies the slices supported by the serving cell. The relay UE 100-2 may specify the slices supported by the serving cell from the slice-specific cell reselection or RACH configuration information provided by the serving cell. The configuration information may be included in a system information block (SIB) broadcast from the serving cell. The configuration information may be included in an RRC release (RRCRelease) message transmitted by unicast from the serving cell. Alternatively, the relay UE 100-2 may specify the slices supported by the serving cell from the cell supported slice information provided by the serving cell. The cell supported slice information may be transmitted as dedicated signaling transmitted by unicast from the serving cell.

Note that the serving cell of gNB 200-1 may transmit QoS configuration information representing a QoS for each of the slices to the relay UE 100-2 as the dedicated signaling. The relay UE 100-2 can judge per slice whether each slice has enough capacity to satisfy a QoS requirement, based on the QoS configuration information. The QoS configuration information may be transmitted by the serving cell to the relay UE 100-2 in response to a request from the relay UE 100-2.

In step S12, the relay UE 100-2 specifies slices capable of being supported by the relay UE 100-2. The relay UE 100-2 may specify the slice specified in step S11 (that is, the slice supported by the serving cell) as a slice capable of being supported by the relay UE 100-2. In addition to this, the relay UE 100-2 may specify the slices capable of being supported by the relay UE 100-2, based on a usage status of radio resources of the relay UE 100-2, a hardware addition status, a congestion status of the Uu link and/or the PC5 unicast link, and the QoS configuration information.

In step S13, the relay UE 100-2 may transmit, to the gNB 200-1, information indicating the slice that is specified in step S12 and is capable of being supported by the relay UE 100-2 (hereinafter, may be referred to as “supportable slice information”). The supportable slice information may be included in the message of the predetermined layer and transmitted.

In step S14, the relay UE 100-2 may specify slices supported by a neighboring relay UE (e.g., second relay user equipment) that neighbors the relay UE 100-2. In this case, the serving cell of the gNB 200-1 can transmit information indicating the slice supported by the neighboring relay UE (hereinafter, may be referred to as “neighboring relay UE slice support information”) to the relay UE 100-2, because the serving cell already acquires the slice supported by the neighboring relay UE in step S13 or the like. The neighboring relay UE slice support information may be included in a message and transmitted to a predetermined layer.

In step S15, the relay UE 100-2 transmits the slice support information (first slice support information) to the remote UE 100-1. Here, the relay UE 100-2 transmits information indicating which slice is capable of being supported by the relay UE 100-2 to the remote UE 100-1. The relay UE 100-2 may transmit a discovery message including the slice support information. The relay UE 100-2 may transmit a PC5-RRC message including the slice support information. The relay UE 100-2 may transmit a PC5-S message including the slice support information.

The slice support information includes an identifier of the slice that is supportable by the relay UE 100-2. The supportable slice may be the slice specified in step S12. The slice support information may include an identifier of the slice supported by the neighboring relay UE. The slice supported by the neighboring relay UE may be the slice specified in step S14. The slice support information including the identifier may be the neighboring relay UE slice support information (second slice support information). The second slice support information may be included in the first slice support information and transmitted as the first slice support information, or the first slice support information and the second slice support information may be separately transmitted.

Note that in the example illustrated in FIG. 9, one relay UE 100-2 transmits the slice support information, but a plurality of relay UEs may respectively transmit the slice support information. Which slice each of the relay UEs is capable of supporting is to be provide to the remote UE 100-1. In this case, the remote UE 100-1 reselects the relay UE supporting the desired slice from among the plurality of relay UEs, based on the plurality of pieces of slice support information in the processing in the subsequent stage.

In step S16, the AS of the remote UE 100-1 is notified of the desired slice (intended slice) from the upper layer (NAS). The desired slice may include priority information for each desired slice.

In step S17, the remote UE 100-1 specifies the desired slice (having the highest priority) and specifies the relay UE supporting the desired slice. In step S17, the remote UE 100-1 judges which relay UE supports the desired slice. The relay UE specified in this manner may be referred to as “specific relay UE”. The remote UE 100-1 specifies the specific relay UE, based on the slice support information. The remote UE 100-1 may specify a plurality of specific relay UEs.

In step S18, the remote UE 100-1 performs processing of raising the priority of the specific relay UE.

For example, as the processing of raising the priority, the remote UE 100-1 may add an offset value to the radio measurement value (SD-RSRP, Sidelink Reference Signal Received Power (SL-RSRP), or the like) of the relay UE. A notification indicating the offset value may be transmitted from the relay UE 100-2. A notification indicating the offset value may be transmitted from the gNB 200-1. The notification from the relay UE 100-2 may be included in a message of a predetermined layer and transmitted. A notification from the gNB 200-1, may be included in a message of the Uu-RRC layer and transmitted. Alternatively, the offset value may be determined by the remote UE 100-1 itself (implementation dependent). Note that the remote UE 100-1 may select only the relay UE as a reselection candidate.

In step S19, the remote UE 100-1 performs relay reselection processing. For example, the remote UE 100-1 performs the following processing. That is, the remote UE 100-1 acquires radio measurement values for surrounding relay UEs. The remote UE 100-1 adds an offset value to the radio measurement value of the specific relay UE. The remote UE 100-1 selects a relay UE of which the radio measurement value exceeds the minimum radio quality level as a candidate relay UE. The remote UE 100-1 may select a relay UE meeting a predetermined criterion (e.g., having the highest radio measurement) from among the candidate relay UEs. The remote UE 100-1 may take the selected relay UE as a suitable relay UE. Since the priority of the specific relay UE is raised for the radio measurement value in step S18, the specific relay UE is likely to be selected as the suitable relay UE in the relay reselection processing.

In step S20, the remote UE 100-1 judges whether the relay reselection is successful. In step S20, when the relay reselection is successful (YES in step S20), the processing proceeds to step S21. On the other hand, when the relay reselection is not successful in step S20 (NO in step S20), the processing proceeds to step S17 again.

Whether the relay reselection is successful is based on whether the remote UE 100-1 can select the suitable relay UE. The remote UE 100-1 may judge that the relay reselection is successful (YES in step S20) when the remote UE 100-1 can select the suitable relay UE. On the other hand, the remote UE 100-1 may judge that the relay reselection is not successful (NO in step S20) when the remote UE 100-1 cannot select the suitable UE because no relay UE supporting the desired slice exists or when the radio measurement value is lower than the minimum radio quality level.

When the processing proceeds to step S17 again, in step S17, the remote UE 100-1 specifies a relay UE supporting the desired slice having the next highest priority as the specific relay UE, and repeats the above-described processing. When the remote UE 100-1 selects a relay UE supporting the desired slice having the lowest priority as the specific relay UE but the relay reselection is not successful, the remote UE 100-1 may not perform reselection by means of the slice-specific relay reselection.

In step S21, the remote UE 100-1 reselects the relay UE supporting the desired slice and camps on the relay UE.

For example, a scenario in which the serving cell of the gNB 200-1 does not provide a target slice for the remote UE 100-1 may be considered. However, as described above, the remote UE 100-1 can indirectly connect to a cell that provides the targeted slice (reselected relay UE) via the relay UE camping on the cell by performing for the procedure the slice-specific relay reselection to access the target slice. This also makes it possible to perform appropriate sidelink relay by means of the slice-specific relay reselection.

### Variation 1 of First Embodiment

In the first embodiment, the procedure for the slice-specific relay reselection has been described. Slice-specific relay selection may also be performed according to the above-described procedure for the slice-specific relay reselection. In this case, in performing the relay reselection (step S18), a relay selection-specific criterion may be used as the predetermined criterion to select a relay UE.

### Variation 2 of First Embodiment

A variation 2 of the first embodiment is an example in which the relay UE 100-2 transmits additional information per slice to the remote UE 100-1.

To be specific, first, the first relay user equipment (e.g., relay UE 100-2) transmits additional information per network slice to the remote user equipment (e.g., remote UE 100-1). Second, the remote user equipment determines whether each of the network slices satisfies a QoS requested by the remote user equipment, based on the additional information, and performs the reselection processing, based on the determined network slice and the first slice support information.

This allows the remote UE 100-1 to reselect the relay UE supporting the slice satisfying the QoS requested by the UE 100-1 in the slice-specific relay reselection. Therefore, in the assumed scenario, sidelink relay can be appropriately performed.

### Operation Example of Second Variation

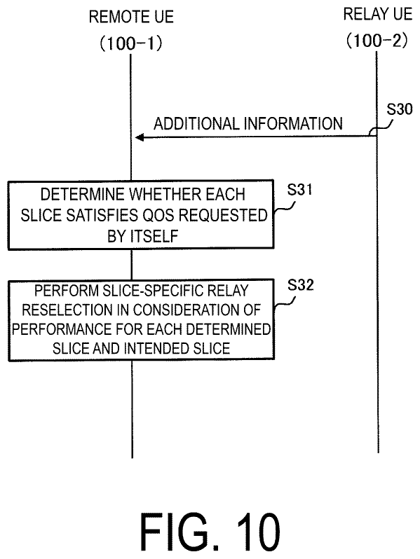

FIG. 10 is a diagram illustrating an operation example according to a variation of the first embodiment.

As illustrated in FIG. 10, in step S30, the relay 100-2 transmits additional information to the remote UE 100-1. The additional information may be included in any one of the discovery message, the PC5-RRC message, or the PC5-S message and transmitted. The additional information may be included in the slice support information of the first embodiment and transmitted. The additional information and the slice support information may be included in an identical message and transmitted. The additional information may be included in a message different from that of the slice support information and transmitted.

The additional information may be the following. That is, the additional information may be information on a resource pool available for each slice and/or a resource pool unavailable (or not allowed) for each slice. The additional information may be information on a resource pool available for each slice and/or a resource pool unavailable (or not allowed) for each slice, and the information may be for each UE. Further, the additional information may be the number of active PC5 connected UEs (remote UE 100-1) for each slice. Further, the additional information may be a throughput supportable for each slice. Further, the additional information may be a delay amount supportable for each slice.

In step S31, the remote UE 100-1 determines whether each the slices satisfies the QoS requested by the remote UE 100-1, based on the additional information. The remote UE 100-1, when judging that a certain slice does not satisfy the QoS requested by the remote UE 100-1, may judge that the relay UE supporting the slice does not satisfy the requirements of the desired slice (intended slice). In this case, the remote UE 100-1 may exclude the relay UE from candidates for slice-specific relay reselection. On the other hand, the remote UE 100-1, when judging that a certain slice satisfies the QoS, may judge that the relay UE supporting the slice satisfies the requirement of the desired slice, and include the relay UE in the specific relay UE (step S17 in FIG. 9).

In step S32, the remote UE 100-1 performs the slice-specific relay reselection processing (in steps S16 to S21 in FIG. 9) in consideration of performance for each determined slice and the desired slice.

### Variation 3

The additional information may include the “slice frequency information” of the serving cell 200-1. As described above, the slice frequency information includes the frequencies specific to the slice and the frequency priority (one or a plurality of priorities) assigned to the respective frequency (one or a plurality of frequencies).

The relay UE 100-2 receives and acquires the slice frequency information of the serving cell 200-1 from the serving cell 200-1 in advance. Therefore, the relay UE 100-2 can transmit the additional information including the slice frequency information to the remote UE 100-1 (step S30).

The remote UE 100-1 can select the specific relay UE in consideration of the slice frequency information in addition to the desired slice and slice support information (step S32). For example, assume a case where the desired slice is supported by two relay UEs, the relay UE #1 and the relay UE #2. For example, assume a case where the slice frequency information includes information indicating that “800 MHz” is used for the desired slice in the relay UE #1 and “3.5 GHz” is used for the desired slice in the relay UE #2. In this case, the remote UE 100-1 can judge that connection to the relay UE #1 is better from the viewpoint of the coverage of the relay UE #1. Then, the remote UE 100-1 can perform the slice-specific relay reselection processing (in steps S16 to S21 in FIG. 9) using the relay UE #1 as the specific relay UE.

### Second Embodiment

A second embodiment is an example in which the gNB 200-1 transmits information on the resource pool used in each slice to the relay UE 100-2.

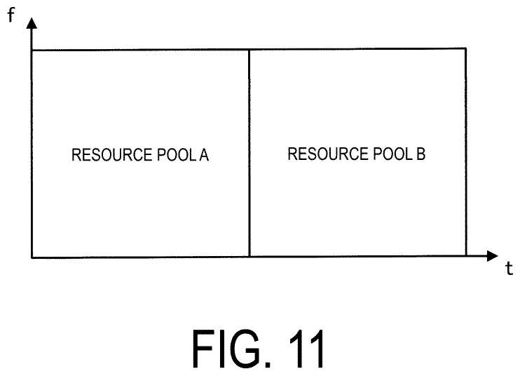

FIG. 11 is a diagram illustrating an example of resource pool allocation. For example, assume that a resource pool A is allocated to be dedicated to the slice A and the resource pool B is allocated to be shared by the slice B and the slice C. In this case, the resource pool A is dedicated to the slice A, to which more resources can be allocated than to the slice B and the slice C. Therefore, access to the slice A can be prioritized over accesses to the slices B and C. Since different resource pools are used for the access to the slice A and the accesses to the slice B and the slice C, interference between these two kinds of accesses can be suppressed.

To be specific, first, the base station (e.g., gNB 200-1) transmits mapping information indicating a correspondence between the network slice and the resource pool to the relay user equipment (e.g., relay UE 100-2). Second, the relay user equipment transmits the mapping information to the remote user equipment (e.g., remote UE 100-1). Third, the remote user equipment and the relay user equipment perform communication to each other using the resource pool (e.g., communication via sidelink relay), based on the mapping information.

This allows, for example, the relay UE 100-2 and the remote UE 100-1 to perform sidelink relay using the slice A priorly over sidelink relay using other slices, based on the mapping information.

### Operation Example According to Second Embodiment

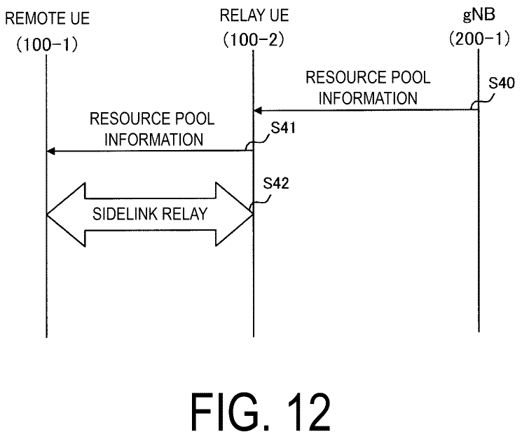

FIG. 12 is a diagram illustrating an operation example according to the second embodiment.

In step S40, the gNB 200-1 transmits resource pool information to the relay UE 100-2.

First, the resource pool information may be mapping information representing a correspondence between a slice and a resource pool. The mapping information may be information designating the slices available for each resource pool. In the example of FIG. 11, the mapping information is information designating the slice A for the resource pool A, and the slices B and C for the resource pool B. The mapping information may be information designating the resource pool available for each slice. In the example of FIG. 11, the mapping information is information designating the resource pool A for the slice A, the resource pool B for the slice B, and the resource pool B for the slice C.

Second, the resource pool information may be mapping information indicating a correspondence between the remote UE 100-1 and the resource pool. The mapping information may be information designating the remote UE 100-1 available for each resource pool. For example, in the example of FIG. 11, the mapping information is information designating the remote UE #1 for the resource pool A, and the remote UE #2 and remote UE #3 for the resource pool B. The mapping information may be information designating the resource pool available for each remote UE 100-1. For example, in the example of FIG. 11, the mapping information is information designating the resource pool A for the remote UE #1, the resource pool B for the remote UE #2, and the resource pool B for the remote UE #3.

Note that the gNB 200-1 may transmit the resource pool information to the relay UE 100-2 by including the resource pool information in a message by a predetermined layer and transmitting the message.

By transmitting the resource pool information, the gNB 200-1 can configure the resource pool for each slice for the relay UE 100-2.

In step S41, the relay UE 100-2 transmits the resource pool information to the remote UE 100-1. For example, the relay UE 100-2 may include the resource pool information in any one of the PC5-RRC message, the PC5-S message, or the discovery message, and transmit the resource pool information. The resource pool information is the same as the resource pool information in step S40. Note that the gNB 200-1 may transmit the resource pool information to the remote UE 100-1. In this case, the gNB 200-1 may transmit a Uu-RRC message or a Uu-PDCP message including the resource pool information to the remote UE 100-1. The relay UE 100-2 configures the resource pool for each slice for the remote UE 100-1 by transmitting the resource pool information to the remote UE 100-1.

In step S42, the relay UE 100-2 and the remote UE 100-1 perform sidelink relay using the resource pool, based on the resource pool information.

### Third Embodiment

A third embodiment is described.

The 3GPP discusses a slice-specific RACH. The slice-specific RACH is a random access procedure performed using a separated random access occasion (separated RACH Occasion (RO)) for each slice (or each slice group) and/or a separated preamble for each slice. The slice-specific RACH can suppress the resource overlapping between the slices, between the slice groups, or between the access using the slice and the access not using the slice, for example. In addition, by avoiding overlapping of the resources, interference of RACHs transmitted by a plurality of UEs 100 can be suppressed. An access to a certain slice (or slice group) can be controlled with priority (by allocating resources in which interference is less likely to occur).

For example, assume the following scenario. That is, the remote UE 100-1 exists that wants to perform communication using the desired slice (intended slice). The relay UE 100-2 supporting the desired slice is in the RRC idle state or the RRC inactive state.

Thus, in such a scenario, the remote UE 100-1 indicates to the relay UE 100-2 that the relay UE 100-2 starts the slice-specific RACH. Accordingly, RRC connection is established between the relay UE 100-2 and the gNB 200-1, and the remote UE 100-1 can perform communication using the desired slice via the relay UE 100-2.

To be specific, first, the remote user equipment (e.g., remote UE 100-1) transmits a connection request message (e.g., PC5-RRC connection request message) to the first relay user equipment (e.g., relay 100-2) to establish a connection (e.g., PC5-RRC connection) to the first relay user equipment. Second, the remote user equipment transmits a predetermined message to the relay user equipment for the first relay user equipment to establish a connection (e.g., Uu-RRC connection) to the base station (e.g., gNB 200-1). Third, the first relay user equipment performs a random access procedure with respect to the base station by using an RACH resource associated with a network slice identifier included in either the connection request message or the predetermined message.

### Operation Example According to Third Embodiment

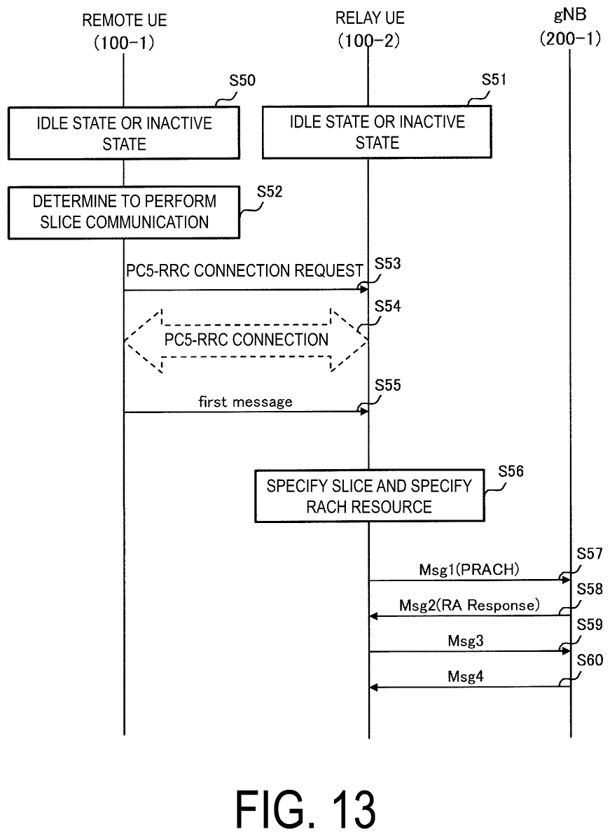

FIG. 13 is a diagram illustrating an operation example according to a third embodiment.

As illustrated in FIG. 13, the remote UE 100-1 is in the RRC idle state or the RRC inactive state (step S50). The relay UE 100-2 is also in the RRC idle state or the RRC inactive state (step S51). During the operation illustrated in FIG. 13, the remote UE 100-1 and the relay UE 100-2 maintain the RRC idle state or the RRC inactive state.

In step S52, the remote UE 100-1 determines to perform communication using the slice. For example, the NAS of the remote UE 100-1 notifies the AS of the remote UE 100-1 of the desired slice (intended slice) and then notifies of the PC5-RRC connection request. Alternatively, the NAS of the remote UE 100-1 may notify the AS of the remote UE 100-1 of the desired slice together with the PC5-RRC connection request. The AS of the remote UE 100-1 may determine to perform communication using the desired slice, based on the notification of the desired slice and the notification of the PC5-RRC connection request.

In Step S53, the remote 100-1 transmits a PC5-RRC connection establishment request message to the relay UE 100-2. The PC5-RRC layer of the remote UE 100-1 may transmit the message to the PC5-RRC layer of the relay UE 100-2.

In step S54, a PC5-RRC connection is established over the PC5 link between the remote UE 100-1 and the relay UE 100-2.

In step S55, the remote UE 100-1 transmits a first message. The first message is a message transmitted from the remote UE 100-1 to the relay UE 100-2 to cause he relay UE 100-2 to establish an RRC connection to the gNB 200-1. The relay UE 100-2, in response to receiving the first message, starts to establish an RRC connection to the gNB 200-1. The first message may be transmitted as an PC5-RRC message. Note that hereinafter, the first message may be referred to as a “predetermined message”.

The predetermined message may be a Msg3 (MSG3: third message) which is a message to be first transmitted in scheduling transmission in the RACH procedure. The Msg3 is an example of the RRC connection request message. The predetermined message may be an RRC setup request (RRCSetupRequest) message. The predetermined message may be an RRC connection resume (RRCResumeRequest) message.

Here, the remote UE 100-1 includes an identifier of the slice (desired slice) determined in step S52 in either the PC5-RRC connection request message (step S53) or the predetermined message (step S55) and transmits the message.

In step S56, the relay UE 100-2 determines to start the RACH procedure in response to receiving the predetermined message. Then, in step S56, the relay UE 100-2 specifies the slice used by the remote UE 100-1 from the identifier of the slice included in the PC5-RRC connection request message or the predetermined message, and specifies an RACH resource associated with the slice. Assume that association information between the slice and the RACH resource is included in a system information block (SIB) from the gNB 200-1, and has been received by the relay UE 100-2 from the gNB 200-1.

In steps S57 to S60, the relay UE 100-2 performs a slice-specific RACH procedure. That is, in step S57, the relay UE 100-2 transmits a Msg1 (MSG1: first message) including a preamble on the PRACH to the gNB 200-1 using the RACH resource specified in step S56 (that is, associated with the desired slice). In step S58, the gNB 200-1 transmits a Msg2 (Msg2: second message) including resource allocation information to the relay UE 100-2. In step S59, the relay UE 100-2 transmits the Msg3 to the gNB 200-1 using the resource of the resource allocation information. When the relay UE 100-2 receives the Msg3 in step S55, the relay UE 100-2 may transmit the Msg3. In step S60, the gNB 200-1 transmits a Msg4 (MSG: fourth message) including control information related to the RRC connection to the relay UE 100-2.

### Variation of Third Embodiment

A variation of the third embodiment is described.

The cell-specific RACH procedure (in steps S57 to S60) described in the third embodiment may be failed due to interference or the like. In this case, the relay UE 100-2 may fail to establish an RRC connection to the gNB 200-1, and the remote UE 100-1 may fail to perform communication using a slice (desired slice) via the relay UE 100-2.

Therefore, in the variation of the third embodiment, an operation or processing when the relay UE 100-2 fails in the RACH procedure is described.

To be specific, first, the first relay user equipment (e.g., relay UE 100-2) transmits a failure message to the remote user equipment (e.g., remote UE 100-1) once the random access procedure has been failed, the failure message including information indicating that the random access procedure has been failed. Second, the remote user equipment performs predetermined processing in response to receiving the failure message. Here, the predetermined processing is either transmitting, by the remote user equipment, a request message to the first relay user equipment, the request message including information indicating that the first relay user equipment is requested to retry the random access procedure, or triggering, by the remote user equipment, reselection of a relay user equipment.

Accordingly, even when the cell-specific RACH procedure is failed in the relay UE 100-2, the procedure is performed again or relay reselection is performed, so that the remote UE 100-1 can appropriately perform communication using the slice.

### Operation Example of Variation

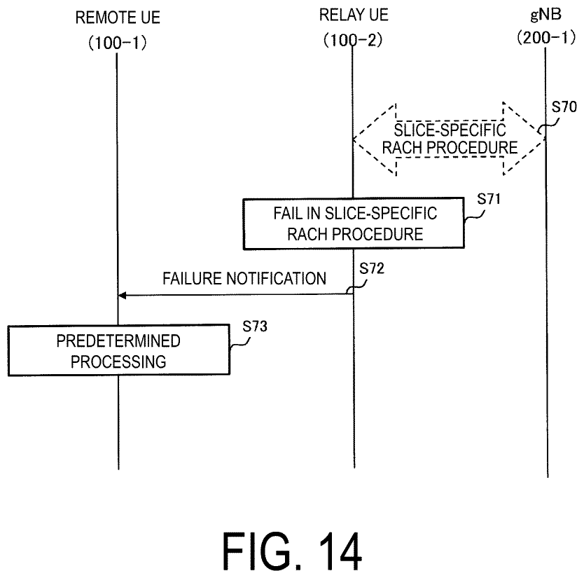

FIG. 14 is a diagram illustrating an operation example according to the variation of the third embodiment. Note that although FIG. 14 illustrates step S70 and subsequent steps, the description is made assuming that before step S70, steps S50 to S55 in the first embodiment (FIG. 13) have been performed.

In step S70, the relay UE 100-2 performs the slice-specific RACH procedure. In this procedure, as in the third embodiment, the relay UE 100-2 transmits the Msg1 using the RACH resource associated with the slice (desired slice) used by the remote UE 100-1 (step S57 in FIG. 13).

In step S71, the relay UE 100-2 detects that the slice-specific RACH procedure has been failed.

In step S72, the relay UE 100-2 transmits a failure message to the remote UE 100-1, the failure message including information indicating that the slice-specific RACH procedure has been failed. The failure message may be transmitted as an PC5-RRC message.

In step S73, the remote UE 100-1 performs predetermined processing in response to receiving the failure message. The predetermined processing is either transmitting, by the remote UE 100-1, a request message to the relay UE 100-2, the request message including information indicating that the relay UE 100-2 is requested to retry the cell-specific RACH procedure, or triggering, by the remote UE 100-1, relay reselection.

When the remote UE 100-1 triggers the relay reselection, the remote UE 100-1 may select a slice (e.g., second network slice) having a priority (e.g., second priority) next to that of a slice (e.g., first network slice) having a priority (e.g., highest priority) used when the relay UE 100-2 is selected. he remote UE 100-1 may select another relay UE supporting the slice in this case. When the remote UE 100-1 triggers the relay reselection, the remote UE 100-1 may exclude the current relay UE 100-2 from the relay reselection candidates and perform the relay reselection processing (e.g., FIG. 9).

### OTHER EMBODIMENTS

A program may be provided that causes a computer to execute each of the processes performed by the UE 100 (also including the relay UE 100-2 and the remote UE 100-1) or the gNB 200. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing processing performed by the UE 100 or the gNB 200 may be integrated, and at least a part of the UE 100 or the gNB 200 may be implemented as a semiconductor integrated circuit (chipset, System on a chip (SoC)).

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. The term “obtain” or “acquire” may mean “obtain/acquire information from stored information,” “obtain/acquire information from information received from another node,” or “obtain/acquire information by generating the information”. The terms “include”, “comprise” and variations thereof do not mean “include only items stated” but instead mean “may include only items stated” or “may include not only the items stated but also other items.” The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

1. A communication control method in a mobile communication system in which communication is performed between a remote user equipment and a base station via a first relay user equipment, the communication control method comprising:
transmitting, by the first relay user equipment, first slice support information to the remote user equipment, the first slice support information comprising a network slice that the first relay user equipment is configured to support; and
performing, by the remote user equipment, reselection processing of reselecting a relay user equipment supporting an intended network slice that the remote user equipment intends to use, based on the first slice support information.

2. The communication control method according to claim 1, further comprising:
transmitting, by the base station, QoS configuration information representing a QoS for each of one or more of the network slices to the first relay user equipment.

3. The communication control method according to claim 1, wherein
the transmitting comprises transmitting, by the first relay user equipment, supportable slice information to the base station, the supportable slice information indicating the network slice that the first relay user equipment is configured to support.

4. The communication control method according to claim 1, wherein
the transmitting comprises transmitting, by the first relay user equipment, second slice support information to the remote user equipment, the second slice support information indicating a network slice supported by a second relay user equipment that neighbors the first relay user equipment, and
the reselecting comprises performing, by the remote user equipment, the reselection processing, based on the first slice support information and the second slice support information.

5. The communication control method according to claim 4, further comprising:
transmitting, by the base station, the second slice support information to the first relay user equipment.

6. The communication control method according to claim 1, wherein
the transmitting comprises transmitting, by the first relay user equipment, additional information for each of one or more of the network slices to the remote user equipment, and
the reselecting comprises determining, by the remote user equipment, whether a QoS requested by the remote user equipment is satisfied for each of one or more of the network slices, based on the additional information, and performing the reselection processing, based on the network slice identified and the first slice support information.

7. A communication control method in a mobile communication system in which communication is performed between a remote user equipment and a base station via a first relay user equipment, the communication control method comprising:
transmitting, by the remote user equipment to the first relay user equipment, a connection request message to establish a connection to the first relay user equipment;
transmitting, by the remote user equipment to the first relay user equipment, a predetermined message to cause the first relay user equipment to establish a connection to the base station; and
performing, by the first relay user equipment, a random access procedure with the base station by using an RACH resource associated with an identifier of a network slice comprised in either the connection request message or the predetermined message.

8. The communication control method according to claim 7, further comprising:
transmitting, by the first relay user equipment, a failure message to the remote user equipment when the random access procedure has been failed, the failure message comprising information indicating that the random access procedure has been failed; and
performing, by the remote user equipment, predetermined processing in response to receiving the failure message,
wherein the predetermined processing is either
transmitting, by the remote user equipment, a request message to the first relay user equipment, the request message comprising information indicating that the first relay user equipment is requested to retry the random access procedure, or
triggering, by the remote user equipment, reselection of a relay user equipment.

9. The communication control method according to claim 8, wherein
the triggering of the reselection of the relay user equipment by the remote user equipment comprises reselecting, by the remote user equipment, reselecting a second relay user equipment supporting a second network slice having a next lower priority than a first network slice supported by the first relay user equipment.

10. The communication control method according to claim 1, wherein
the remote user equipment and the first relay user equipment are in an RRC idle state or an RRC inactive state.

11. A relay user equipment in a mobile communication system in which communication is performed between a remote user equipment and a base station via the relay user equipment, the relay user equipment comprising:
a receiver configured to
receive from the remote user equipment, a connection request message for establishing a connection between the remote user equipment and the relay user equipment, and
receive from the remote user equipment, a predetermined message causing the relay user equipment to establish a connection to the base station, and
a controller configured to perform a random access procedure with the base station by using an RACH resource associated with an identifier of a network slice included in either the connection request message or the predetermined message.
